(19) United States
(12) Patent Application Publication
(10) Pub. No.: US 2023/0100919 A1
(43) Pub. Date: Mar. 30, 2023

(54) CAR CONTROLLER FOR AN ELEVATOR CAR OF AN ELEVATOR SYSTEM, ELEVATOR SYSTEM, USE OF A CAR CONTROLLER, AND METHOD FOR CONTROLLING A CAR DOOR OF AN ELEVATOR CAR OF AN ELEVATOR SYSTEM

(71) Applicant: Inventio AG, Hergiswil (CH)

(72) Inventor: Claudio Colombano, Beckenried (CH)

(21) Appl. No.: 17/760,196

(22) PCT Filed: Feb. 4, 2021
(86) PCT No.: PCT/EP2021/052609

§ 371 Date: Aug. 5, 2022

(30) Foreign Application Priority Data
Feb. 12, 2020 (EP) 20156943.1

(51) Int. Cl. B66B 13/14; B66B 13/24

(52) U.S. Cl. CPC B66B 13/146; B66B 13/24

(57) ABSTRACT

A car controller for an elevator car of an elevator system can be arranged on the elevator car. The car controller obtains a primary door opening request from an elevator controller of the elevator system, obtains at least one control signal, the at least one control signal indicating whether the elevator car is in a state intended for opening a car door of the elevator car, and transmits or withholds a secondary door opening request on the basis of the primary door opening request and the at least one control signal.

### FIELD

The invention relates to a car controller for an elevator car of an elevator system, an elevator system, use of a car controller, and a method for controlling a car door of an elevator car of an elevator system.

### BACKGROUND

Known elevator systems for transporting people or loads comprise an elevator car which can be moved vertically in an elevator shaft. The elevator car usually comprises a car door, which is opened in order to allow passengers to board or disembark from a boarding platform, for example on a floor of a building. In known elevator systems, the elevator system is controlled by an elevator controller, which is arranged, for example, in a machine room of the elevator system. Among other things, the elevator controller controls the car door of the elevator car. To open the car door, the elevator controller transmits a car door opening signal to the elevator car and the car door is then opened. However, in the case of known elevator systems, the elevator control can transmit an erroneous car door opening signal to the elevator car if there is a fault in the elevator controller.

### SUMMARY

An object of the invention is to specify a car controller for an elevator car of an elevator system and in particular an elevator system which is improved compared to elevator controllers or elevator systems known from the prior art, with the safety precautions for opening the car door in particular being increased. Furthermore, it is an object of the invention to specify a method for controlling a car door of an elevator car of an elevator system.

The objects are achieved with a car controller and a use and a method according to the advantageous developments and embodiments that can be found in the description.

One aspect of the invention relates to a car controller for an elevator car of an elevator system. The car controller is designed to be arranged on the elevator car, and the car controller is designed to obtain a primary door opening request from an elevator controller of the elevator system; obtain at least one control signal, the at least one control signal indicating whether the elevator car is in a state intended for opening a car door of the elevator car; and transmit or withhold a secondary door opening request on the basis of the primary door opening request and the at least one control signal.

A further aspect of the invention relates to an elevator system, comprising an elevator car with a car controller according to the embodiments described herein and a car door; and an elevator controller for controlling the elevator system.

Yet another aspect of the invention relates to using a car controller according to the embodiments described herein in an elevator car of an elevator system.

A further aspect of the invention relates to a method for controlling a car door of an elevator car of an elevator system, comprising obtaining a primary door opening request by a car controller of the elevator car; obtaining at least one control signal by the car controller, the at least one control signal indicating a state of the elevator car which is intended for opening a car door of the elevator car; and transmitting or withholding a secondary door opening request by the car controller based on the primary door opening request and the at least one control signal.

In preferred embodiments, the car controller is arranged in or on the elevator car. In particular, the car controller moves with the elevator car. The car controller is preferably arranged on a roof of the elevator car. In preferred embodiments, the car controller is designed for installation in or on an elevator car and/or for replacing an existing controller of an elevator car. In further preferred embodiments, the car controller is produced by retrofitting an existing controller, by updating the software of an existing controller, or by converting an existing controller of the elevator car into a car controller according to the embodiments described herein. In preferred embodiments, the car controller comprises or is a controller, a microcontroller, a control circuit or a printed circuit board (PCB).

An elevator controller of the elevator system is preferably arranged outside the elevator car. In particular, the elevator controller does not move with the elevator car. For example, the elevator controller is arranged in a machine room of the elevator system or in an elevator shaft of the elevator system, for example in a shaft head of the elevator system. The elevator controller is preferably arranged in a stationary manner. In particular, the elevator controller is not arranged in or on the elevator car. The elevator controller preferably comprises a controller, a microcontroller, or a computer. In particular, the elevator controller can have greater complexity and/or computing power than the car controller.

The elevator controller preferably accepts input from passengers, for example transport requests via an interior panel of the elevator car or exterior panels on boarding platforms, and data about the state of the elevator system from other controllers and/or sensors, for example data about a movement of the elevator car and/or a position of the elevator car. In particular, the elevator controller controls the movement of the elevator car, shaft doors on the boarding platforms, and/or the car door of the elevator car to transport the passengers.

If the elevator controller determines that the car door should be opened, the elevator controller transmits a primary door opening request to the car controller of the elevator car. However, there is a possibility that the elevator controller erroneously determines that the car door should be opened, for example due to erroneous data about the state of the elevator system, due to a defect in the elevator controller, due to a software error, or due to a transmission error. If the elevator controller erroneously determines that the car door should be opened, the elevator controller may erroneously transmit a primary door opening request to the car controller.

In preferred embodiments, the car controller is designed to obtain the primary door opening request from the elevator controller. The car controller preferably obtains the primary door opening request via a primary signal connection, for example a wired communication connection between the elevator controller and the car controller.

In preferred embodiments, the car controller is designed to obtain at least one control signal, the at least one control signal indicating whether the elevator car is in a state intended for opening a car door of the elevator car. As used herein, “indicating” means, for example, “showing,” “being an indication,” or “containing information.” The at least one control signal preferably comprises at least one piece of information or at least one value, for example a Boolean value or a Boolean signal. The car controller can be designed to obtain the at least one control signal from a control signal generator of the elevator system, for example another controller of the elevator system and/or a sensor of the elevator system, for example via a control signal connection between the control signal generator and the car controller.

The car controller is preferably designed to transmit or withhold a secondary door opening request based on the primary door opening request and the at least one control signal. In preferred embodiments, the car door is opened if the secondary door opening request is transmitted and is not opened if the secondary door opening request is withheld, in particular when the secondary door opening request is not transmitted or not generated. The secondary door opening request is preferably transmitted if the at least one control signal indicates that the elevator car is in a state intended for opening the car door. The secondary door opening request is preferably withheld if the at least one control signal indicates that the elevator car is not in a state intended for opening the car door.

When transmitting the secondary door opening request, the secondary door opening request is preferably transmitted from the car controller to a door opening mechanism for opening the car door. The door opening mechanism comprises, for example, a car door drive, which is designed to open the car door, and/or a door unlocking mechanism for unlocking the car door. If the secondary door opening request is transmitted, the car door is opened in particular by the door opening mechanism. The opening of the car door as a result of a secondary door opening request corresponds, for example, to normal operation if the elevator car reaches a travel destination.

When withholding the secondary door opening request, the car door is not opened. The withholding preferably comprises discarding the primary door opening request. In further preferred embodiments, the car controller can be designed to obtain the at least one control signal again at least once if the secondary door opening request is withheld and to transmit or withhold a secondary door opening request based on the primary door opening request and the at least one control signal which is obtained again.

By transmitting or withholding the secondary door opening request according to embodiments described herein, a primary door opening request from the elevator controller can in particular be checked locally in the elevator car for plausibility based on at least one control signal. If there is a primary door opening request erroneously transmitted by the elevator controller, the secondary door opening request can be withheld on the basis of the at least one control signal. The probability that both an erroneous primary door opening request and an erroneous control signal or a number of erroneous control signals are present is lower, in particular significantly lower, than the probability of a faulty primary door opening request alone. In particular, the probability that the car door is opened in a state that is not intended for opening the car door can be reduced. The safety precautions to protect against erroneous opening of the car door can be increased by car controllers according to the embodiments described herein compared to known elevator systems. A susceptibility to errors when opening the car door can in particular be reduced in embodiments, since the car controller according to preferred embodiments has a lower complexity than the elevator controller and is, for example, less error-prone than the elevator controller. Furthermore, the susceptibility to interference in the event of transmission errors can be reduced.

In preferred embodiments, the at least one control signal comprises at least one from the group of a standstill signal, a door zone signal, and a door override signal.

The at least one control signal preferably comprises a standstill signal, the standstill signal indicating a standstill or a movement of the elevator car. A standstill signal, which indicates that the elevator car is at a standstill, preferably indicates that the elevator car is in a state in which the car door is intended to be opened. For example, a hazard to passengers can be low even if the primary door opening request is transmitted erroneously if the elevator car is stationary.

In preferred embodiments, the opening of the car door can be intended during a movement of the elevator car under specific conditions, for example during a height compensation movement of the elevator car in a region of a boarding platform. In particular in such embodiments, a movement-indicating standstill signal indicates neither a state of the elevator car intended for opening the car door nor a state not intended for opening. In such embodiments, transmitting or withholding the secondary door opening requests can be based, for example, on at least one further control signal.

In further embodiments, an opening of the car door is generally not intended during a movement of the elevator car. In such embodiments, a movement-indicating standstill signal can indicate that the elevator car is not in a state in which the car door is intended to be opened. In such embodiments, the secondary door opening request is withheld upon a movement-indicating standstill signal.

In embodiments, the standstill signal is provided by a speed sensor of the elevator system. The speed sensor can be designed to indicate a speed or a movement of the elevator car. In particular, the speed sensor can be designed as a speed sensor of an elevator drive. For example, the speed sensor can be a movement sensor, an encoder, a tachometer, or a speed controller of the elevator drive. The elevator drive is preferably arranged in a machine room of the elevator system or in the elevator shaft, for example in a shaft head of the elevator system. The standstill signal is preferably transmitted via a standstill signal connection between the speed sensor and the car controller, for example via a line or a wire along a carrier means of the elevator system, via a network of the elevator system, or via a radio link.

In preferred embodiments, the at least one control signal comprises a door zone signal, the door zone signal indicating whether the elevator car is in a door zone of the elevator system. A door zone, in particular a door zone of a shaft door, comprises a vertical zone in the region of a shaft door. The door zone of a shaft door is in particular dimensioned such that when the elevator car is located in the door zone, a height difference between a boarding platform on the shaft door and the car floor of the elevator car allows safe boarding into the elevator car or disembarking from the elevator car. In particular, the door zone is dimensioned such that the height difference is no greater than a limit value, for example a standardized or prescribed limit value, the limit value being in particular less than 30 cm, in particular less than 20 cm or less than 15 cm.

The door zone signal is preferably provided by a shaft information system of the elevator car. In particular, the shaft information system is at least partially arranged in or on the elevator car. For example, the shaft information system comprises a door zone sensor on the elevator car. In particular, the door zone sensor can be designed to detect a door zone by means of door zone indicators of the shaft information system arranged in the elevator shaft. For example, the door zone sensor can be designed as a light barrier for detecting door zones, in particular for detecting the door zones using metal flags arranged in the elevator shaft as door zone indicators. The door zone signal can be transmitted from the shaft information system to the car controller via a door zone signal connection of the elevator car.

In preferred embodiments, the at least one control signal comprises a door override signal, the door override signal indicating whether opening of the car door is permitted during a movement of the elevator car. A door override signal is usually used to activate an override of a safety circuit on the car door. If the safety circuit is not overridden, for example, a moving elevator car can be braked for safety reasons when the car door is opened. If the safety circuit is overridden, the car door can also be opened when the elevator car is moving. In particular, a door override signal can be transmitted to the car controller when a speed of the elevator car is lower than a speed limit value, for example during a height compensation between the car floor of the elevator car and the floor of a boarding platform or just before or during the arrival of the elevator car in a door zone. Opening the car door during a movement of the elevator car often serves to increase the transport rate of the elevator system.

Preferably, the door override signal indicates that opening of the car door during movement is permitted when a speed of the elevator car is lower than a speed limit value. A speed limit value can be a normalized or prescribed speed limit value. For example, a speed limit value can be less than 1 m/s, in particular less than 0.8 m/s or less than 0.3 m/s. In preferred embodiments, the door override signal is provided by the elevator controller. For example, the door override signal can be transmitted to the car controller via the primary signal connection.

In preferred embodiments, the car controller is designed to transmit the secondary door opening request, in particular to transmit it precisely if or only if the car controller obtains a primary door opening request and the standstill signal indicates a standstill of the elevator car; or if the car controller obtains a primary door opening request and the standstill signal indicates movement of the elevator car and the door zone signal indicates that the elevator car is in a door zone and the door override signal indicates that opening of the car door is permitted.

In further preferred embodiments, the car controller is designed to transmit the secondary door opening request, in particular to transmit it precisely if or only if the car controller obtains a primary door opening request and the standstill signal indicates a standstill of the elevator car and the door zone signal indicates that the elevator car is in a door zone; or if the car controller obtains a primary door opening request and the standstill signal indicates movement of the elevator car and the door zone signal indicates that the elevator car is in a door zone and the door override signal indicates that opening the car door is permitted.

In exemplary embodiments, the car controller is designed, when obtaining the primary door opening request and the control signals, to transmit or withhold the secondary door opening request based on a check of the control signals in the following order. First, the car controller checks the standstill signal. If the standstill signal indicates a standstill of the elevator car, the car controller transmits the secondary door opening request. Alternatively, if the standstill signal indicates that the elevator car is at a standstill, the car controller can check the door zone signal. The car controller transmits the secondary door opening request if the door zone signal indicates that the elevator car is in a door zone, or withholds the secondary door opening request if the door zone signal indicates that the elevator car is not in a door zone. If the standstill signal indicates movement of the elevator car, the car controller next checks the door zone signal. If the door zone signal indicates that the elevator car is not in a door zone, the car controller withholds the secondary door opening request. If the door zone signal indicates that the elevator car is in a door zone, the car controller next checks the door override signal. If the door override signal indicates that opening of the car door is not permitted, the car controller withholds the secondary door opening request. If the door override signal indicates that opening of the car door is allowed, the car controller transmits the secondary door opening request.

In preferred embodiments, at least one of the standstill signal, the door zone signal, and the door override signal is a Boolean signal or value or is converted to a Boolean signal or value by the car controller, for example by using a threshold method.

Elevator systems according to preferred embodiments comprise an elevator car having a car controller according to embodiments described herein. The elevator car comprises a car door which can preferably be opened and/or closed by a door opening mechanism. The elevator car is preferably arranged in an elevator shaft and can in particular be moved vertically. The elevator car is usually connected to a counterweight via a carrier means. In order to move the elevator car, the carrier means is driven by an elevator drive. The elevator drive is arranged, for example, in a machine room of the elevator system or in a shaft head of the elevator system.

According to embodiments, the elevator system comprises an elevator controller for controlling the elevator system. The elevator controller is preferably arranged in a stationary manner. In preferred embodiments, the elevator system comprises at least one control signal generator for providing at least one control signal. For example, the elevator system comprises a speed sensor of an elevator drive, in particular for providing a standstill signal, and/or a shaft information system, in particular for providing a door zone signal. In particular, the elevator controller can be designed to provide a door override signal.

Preferred embodiments of methods for controlling a car door comprise controlling the car door using a car controller according to embodiments described herein and in particular an elevator controller of the elevator system. The method preferably comprises transmitting a primary door opening request by an elevator controller of the elevator system. In preferred embodiments, the method comprises the car controller obtaining the primary door opening request.

The method comprises the car controller obtaining at least one control signal, the at least one control signal indicating whether the elevator car is in a state intended for opening a car door of the elevator car. The at least one control signal preferably comprises at least one from the group of the standstill signal, the door zone signal, and the door override signal. The method preferably comprises the car controller transmitting or withholding a secondary door opening request based on the primary door opening request and the at least one control signal. In particular, the transmitting or withholding based on the at least one control signal comprises checking the at least one control signal, for example as described herein for the car controller. Preferred embodiments of the method can be implemented, for example, as a program for execution on the car controller, wherein the car controller can be designed in particular as a microcontroller, as a printed circuit board (PCB), or as a control circuit.

Preferred embodiments can offer the advantage over the prior art that the safety precautions to protect against erroneous opening of the car door are improved. In particular, an additional protective device can be provided by a local check of the plausibility of a primary door opening request. A further advantage can be that the primary door opening request is checked at least partially independently of the elevator controller. A probability of erroneous opening of the car door can be reduced in particular due to a low susceptibility to errors in a car controller that is less complex than the elevator controller. A further advantage can be that the car controller according to embodiments can be produced by replacing or retrofitting existing controllers of elevator cars. In particular, embodiments described herein can provide cost-effective solutions for increasing the security of car doors.

### DESCRIPTION OF THE DRAWINGS

Various aspects of the invention are explained in more detail with reference to embodiments in conjunction with the drawings, in which:

FIG. 1 is a schematic view of a preferred embodiment of a car controller in an elevator system;

FIG. 2 is a schematic representation of a preferred method for controlling a car door;

FIG. 3 is a schematic view of a further preferred embodiment of a car controller in an elevator system; and

FIG. 4 is a schematic representation of a further preferred method for controlling a car door.

### DETAILED DESCRIPTION

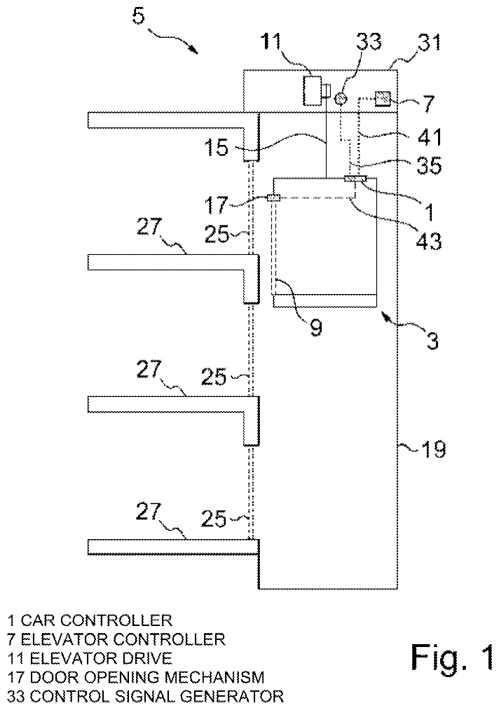

FIG. 1 is a schematic view of an elevator system 5 having an elevator car 3 and a car controller 1 of the elevator car 3. The elevator car 3 is arranged in an elevator shaft 19 of the elevator system 5. The elevator car 3 is connected to a counterweight (not shown) via a carrier means 15. In order to move the elevator car 3, the carrier means 15 is driven by an elevator drive 11 of the elevator system 5. The elevator car 3 comprises a car door 9 which can be opened and closed by a door opening mechanism 17. The elevator system 5 of FIG. 1 comprises boarding platforms 27 and shaft doors 25 on a plurality of floors.

The elevator system 5 comprises an elevator controller 7 for controlling the elevator system 5. The elevator controller 7 is arranged, for example, in a machine room 31 of the elevator system 5 and is in communication with the car controller 1 of the elevator car 3 via a primary signal connection 41, for example a communication line in FIG. 1. The elevator controller 7 controls, in particular, a movement of the elevator car 3, opening and closing of shaft doors 25, and/or opening and closing of the car door 9 via the car controller 1. The elevator controller 7 controls the elevator system 5, for example based on inputs from passengers in the elevator car 3 and/or on the boarding platforms 27, and based on data about the state of the elevator system 5, for example based on data about a position and speed of the elevator car 3.

If the elevator controller 7 correctly or erroneously determines that the car door 9 of the elevator car 3 should be opened, the elevator controller 7 transmits a primary door opening request to the car controller 1 via the primary signal connection 41. The car controller 1 of the elevator car 3 is arranged on a roof of the elevator car 3 in FIG. 1 by way of example. The car controller 1 is in communication with the door opening mechanism 17 of the elevator car 3 via a secondary signal connection 43. In addition, the car controller 1 is in communication with a control signal generator 33 via a control signal connection 35. In FIG. 1, the control signal generator 33 is arranged in the machine room 31 by way of example. In further embodiments, the at least one control signal generator 33 can be arranged in particular in or on the elevator car 3, in the elevator shaft 19, and/or in the machine room 31.

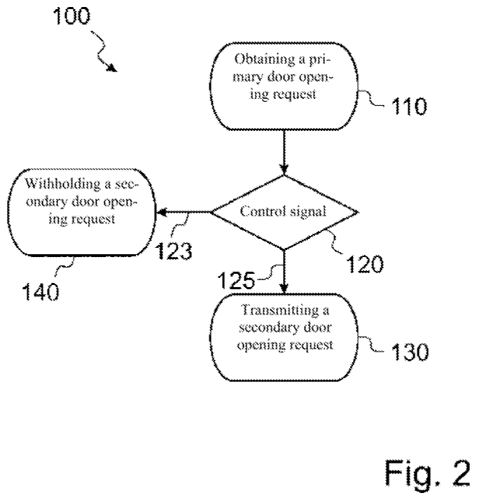

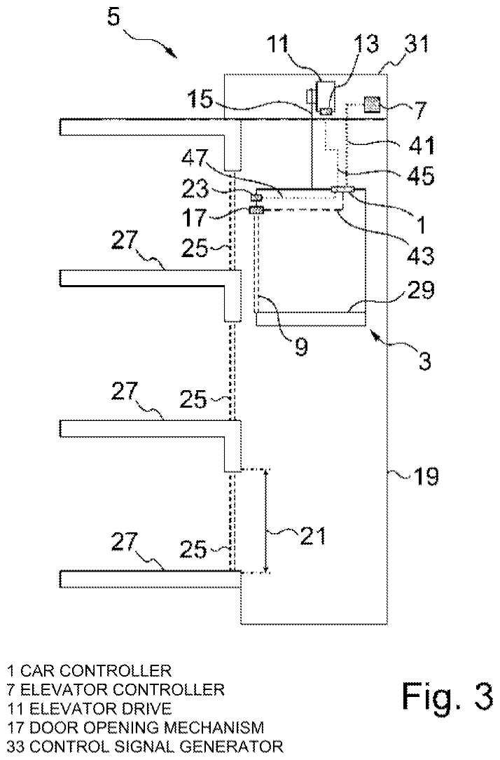

In particular, the car controller 1 is designed to execute the method 100 explained in connection with FIG. 2, which can be present, for example, as a program for execution on the car controller 1. However, the method 100 can also be implemented in a different way, in particular in a different embodiment of an elevator system that is described in FIG. 3. At 110, the car controller 1 obtains the primary door opening request transmitted by the elevator controller 7. At 120, the car controller 1 obtains at least one control signal, in particular from the control signal generator 33. The at least one control signal indicates whether the elevator car 3 is in a state intended for opening the car door 9.

If (123) the at least one control signal indicates that the elevator car 3 is not in a state in which the car door 9 is intended to be opened, a secondary door opening request is withheld at 140; it is in particular not transmitted to the door opening mechanism 17 of the elevator car 3. The car door 9 of the elevator car 3 remains closed at 140. If (125) the at least one control signal indicates that the elevator car 3 is in a state intended for opening the car door 9, a secondary door opening request is transmitted at 130, in particular to the door opening mechanism 17 of the elevator car 3. After 130, the door opening mechanism 17 opens the car door 9.

FIG. 3 shows another preferred embodiment of a car controller 1 in an elevator system 5. Features that are the same or similar to those in FIG. 1 are provided with the same reference signs and are not described again below for the sake of clarity. In FIG. 3, the car controller 1 is in communication with an elevator controller 7 via a primary signal connection 41. The elevator controller 7 is designed to transmit a primary door opening request to the car controller 1 if the elevator controller 7 determines that the car door 9 of the elevator car 3 should be opened. The elevator controller 7 of FIG. 3 is also designed to provide a door override signal to the car controller 1, in particular if the conditions for overriding a safety circuit of the car door are met. The conditions can be met, for example, if the elevator car is moving slower than a speed limit value, in particular during height compensation between a car floor 29 of the elevator car and a boarding platform 27 and/or during the arrival of the elevator car 3 in a door zone 21 of a shaft door 25.

The car controller 1 is in communication with a speed sensor 13 of an elevator drive 11 via a standstill signal connection 45. In FIG. 3, the speed sensor 13 is provided by a motion sensor, for example by an encoder of an elevator drive 11 indicating a movement or a standstill. The speed sensor 13 provides a standstill signal to the car controller 1, the standstill signal indicating a movement or a standstill of the elevator car 3.

The car controller 1 is in communication with a shaft information system 23 via a door zone signal connection 47. The shaft information system 23 is designed to provide a door zone signal to the car controller 1. The door zone signal indicates whether the elevator car 3 is in a door zone 21 of a shaft door 25. In FIG. 3, only one door zone 21 is shown as an example, each of the shaft doors 25 having a corresponding door zone 21. The door zones 21 of the shaft doors 25 are dimensioned such that a height difference between a boarding platform 27 assigned to the door zone 21 and a car floor 29 of an elevator car 3 located in the door zone 21 is not greater than a limit value, for example 15 cm. The shaft information system 23 comprises, for example, a light barrier which is arranged on the elevator car 3 and is designed to detect metal flags arranged in the elevator shaft 19. The metal flags are arranged in such a way that the light barrier detects a metal flag if the elevator car 3 is in a door zone 21 associated with the metal flag.

In FIG. 3, the car controller 1 is also in communication with a door opening mechanism 17 via a secondary signal connection 43. If the elevator controller 7 determines that the car door 9 should be opened, the elevator controller 7 transmits a primary door opening request to the car controller 1. The car controller 1 checks the primary door opening request for plausibility using at least one of the group of the standstill signal, the door zone signal, and the door override signal and determines to transmit or withhold the secondary door opening request.

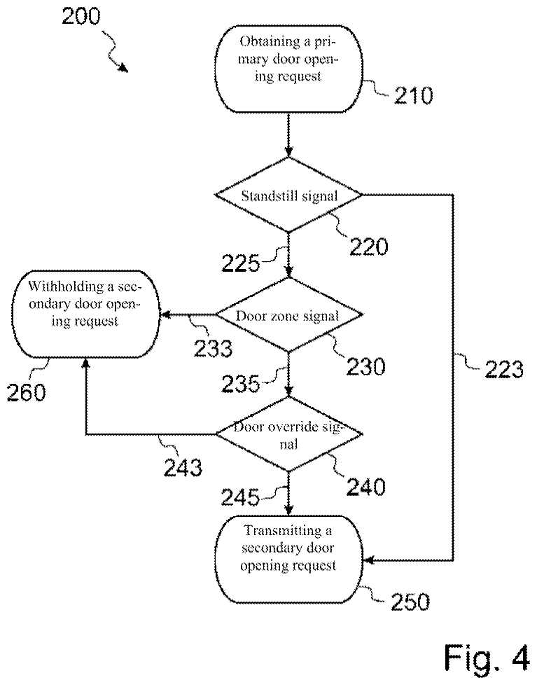

In particular, the car controller 1 is designed to execute the method 200 explained in connection with FIG. 4. However, the method 200 can also be implemented in a different way, in particular in a different embodiment of an elevator system than that described in FIG. 3. At 210, the car controller 1 obtains the primary door opening request. The car controller 1 obtains at least one control signal, wherein obtaining the at least one control signal comprises obtaining a standstill signal, in particular at 220, obtaining a door zone signal, in particular at 230, and obtaining a door override signal, in particular at 240. At 220, the car controller 1 checks a standstill signal which is provided in particular by the speed sensor 13. If (223) the standstill signal indicates a standstill of the elevator car 3, the car controller transmits at 250 a secondary door opening request, in particular to the door opening mechanism 17 of the elevator car 3 to open the car door 9.

If (225) the standstill signal indicates a movement of the elevator car 3, the car controller 1 checks a door zone signal at 230, which door zone signal is provided in particular by a shaft information system 23. If (233) the door zone signal indicates that the elevator car 3 is not in a door zone 21, the car controller 1 withholds at 260 the secondary door opening request. The primary door opening request is discarded and the car door 9 remains closed.

If (235) the door zone signal indicates that the elevator car 3 is in a door zone 21, the car controller checks at 240 a door override signal provided by the elevator controller 7 in particular. If (243) the door override signal indicates that the opening of the car door is not allowed during the movement of the elevator car, the car controller 1 withholds at 260 the secondary door opening request. The primary door opening request is discarded and the car door 9 remains closed. If (245) the door override signal indicates that the opening of the car door 9 is permitted during the movement of the elevator car 3, for example if a speed of the elevator car 3 is lower than a speed limit value, the car controller 1 transmits at 250 the secondary door opening request, in particular to the door opening mechanism 17 of the elevator car 3 for opening the car door 9.

By way of example, the exemplary method 200 or other preferred embodiments reduce the probability of passengers being endangered by an erroneous primary door opening request. In particular, opening a car door while the elevator car is at a standstill can be relatively harmless. In the case of a moving elevator car, a hazard is particularly unlikely if the elevator car is in a door zone and door override is activated. Preferred embodiments can thus in particular increase the safety precautions to protect passengers.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A car controller for an elevator car of an elevator system, wherein the car controller is adapted to be arranged on the elevator car, the car controller comprising:
a primary signal connection to an elevator controller of the elevator system to obtain a primary door opening request from the elevator controller;
a secondary signal connection to a door opening mechanism of the elevator car to transmit a secondary door opening request to the door opening mechanism;
a signal connection to obtain at least one control signal, the at least one control signal indicating whether the elevator car is in a state intended for opening a car door of the elevator car, or the at least one control signal being a door zone signal indicating whether the elevator car is in a door zone of the elevator system, or the at least one control signal being a door override signal indicating whether opening the car door is permitted during a movement of the elevator car; and
wherein the car controller, based on the primary door opening request and the at least one control signal, transmits a secondary door opening request to the door opening mechanism by the secondary signal connection or withholds the secondary door opening request.

15. The car controller according to claim 14 wherein the at least one control signal is a standstill signal indicating a standstill or a movement of the elevator car.

16. The cabin controller according to claim 15 wherein the standstill signal is provided by a speed sensor of the elevator system.

17. The car controller according to claim 15 wherein at least one of the standstill signal, the door zone signal, and the door override signal is a Boolean signal.

18. The car controller according to claim 14 wherein the door zone signal is provided by a shaft information system of the elevator car.

19. The car controller according to claim 14 wherein opening of the car door during a movement of the elevator car is permitted if a speed of the moving elevator car is lower than a speed limit value.

20. The car controller according to claim 14 wherein the door override signal is provided by the elevator controller.

21. The car controller according to claim 14 wherein the car controller transmits the secondary door opening request:
when the car controller obtains the primary door opening request and the standstill signal indicating a standstill of the elevator car; or
when the cabin controller obtains the primary door opening request, the standstill signal indicating a movement of the elevator car, the door zone signal indicating that the elevator car is in a door zone, and the door override signal indicating that opening the car door is permitted.

22. An elevator system comprising:
an elevator car;
a car controller according to claim 14;
a car door of the elevator controlled by the car controller; and
an elevator controller controlling the elevator system.

23. The elevator system according to claim 22 wherein the elevator controller is stationary in the elevator system.

24. The elevator system according to claim 22 wherein the car controller is arranged on the elevator car.

25. A method for controlling a car door of an elevator car of an elevator system, the method comprising the steps of:
obtaining a primary door opening request by a car controller of the elevator car;
obtaining at least one control signal by the car controller, the at least one control signal indicating a state of the elevator car which is intended for opening a car door of the elevator car; and
transmitting or withholding a secondary door opening request by the car controller based on the primary door opening request and the at least one control signal to control the car door.

26. The method according to claim 25 wherein, prior to obtaining the primary door opening request, transmitting the primary door opening request by an elevator controller of the elevator system.
